(19) United States
(12) Patent Application Publication
(10) Pub. No.: US 2009/0308987 A1
(43) Pub. Date: Dec. 17, 2009

(54) Arcadia stud clip

(76) Inventor: Alexis E. Devora Martha Exposito, Naples, FL (US)

Correspondence Address: Alexis Devora, 107 Iakeside Dr, Naples, FL, 34112, US

(21) Appl. No.: 12/214,061

(22) Filed: Jun. 17, 2008

(51) Int. Cl. F16L 3/00

(52) U.S. Cl. 248/70; 248/73

(57) ABSTRACT

The arcadia stud clip is composed by 3 piece 1—is the base of the arcadia stud clip that has the two hooks in the back, the 2 is the flex or spring steel piece that will push the metal stud to the back against to the hooks and the 3—is the aluminum strap that will strapping the MC cable. This 3 piece are attach with a rivet or pop rivet.

The arcadia stud clip is steel piece design for clipping into the metal stud very tied that never came out or will never loss from the metal stud. The strap is made of aluminum for protect the MC cable and keeping in the center of the metal stud.

This object will work in commercial and residential field of electricity with the purpose of the safety of the MC cable and fast production. This object work in the way that clipping in to the metal stud with press ion that will be very tied.

The arcadia stud clip and the strap that strapping the Mc cable both are attached by a rivet or pop rivet. The arcadia stud clip is made of steel for better flexibility that will hold very tied the metal stud.

The object work by pushing the arcadia stud clip inside the metal stud all the way in until the two hooks clip in the back side of the metal stud in that way the arcadia stud clip will be very tied in the metal stud

The arcadia stud clip is composed by two important piece, 1—is the two hooks that will hold very tied in the back side of the metal stud and 2—is the spring or the flex metal that push the metal stud to the back. Both piece will hold the metal stud very tied.

The strap that is attached to the arcadia stud clip by a rivet or pop rivet is for MC cable, this aluminum strap has important function that will strapping in the center all the MC cable that is hanger in the metal stud.

### FIGURES OF THE DESIGN

FIG. 1—Top view of the arcadia stud clip. The only piece that will be patent is the piece that clip to the metal stud. FIG. A—we can see the two hooks of the arcadia stud clip. This hooks will clip in the metal stud. FIG. B—we can see the flex or spring metal that will push the metal stud to the back against to the two hooks, and this way the arcadia stud clip will be very tied to the metal stud.

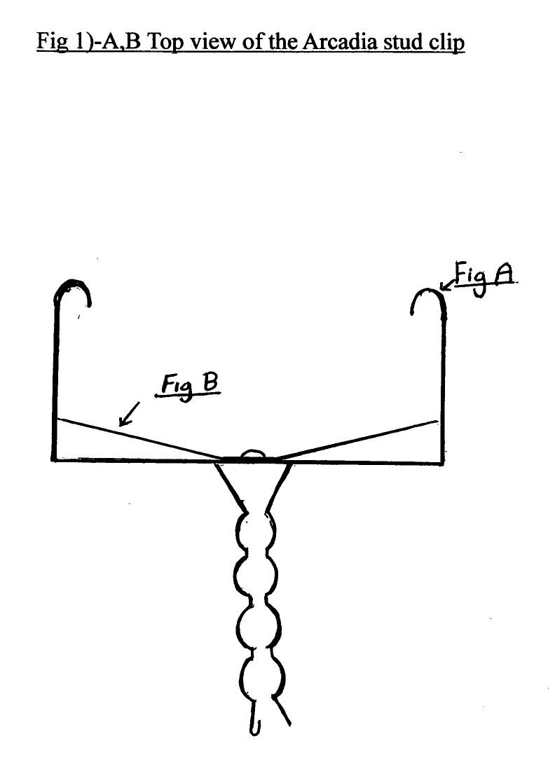

FIG. 2—Button view of the arcadia stud clip. We can see the aluminum strap for the MC cable. This strap has a clip in the end for close the strap.

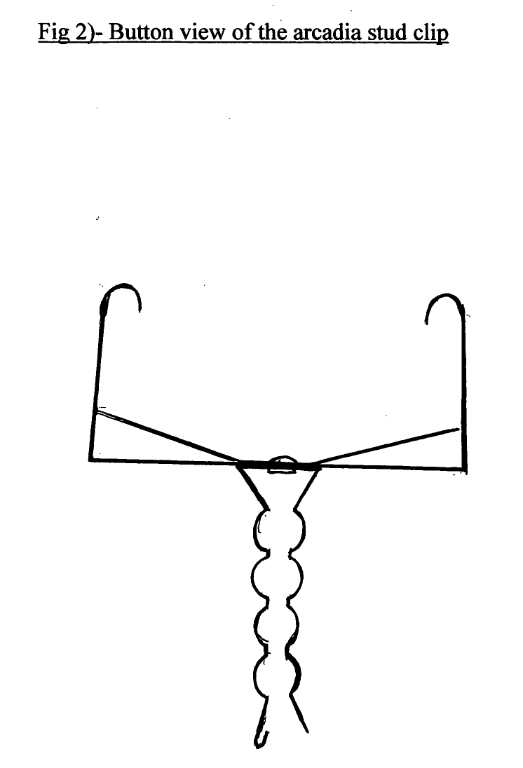

FIG. 3—Front side view of the arcadia stud clip. We can see the strap has a pop rivet or rivet in the center, this rivet attach the arcadia stud clip and the strap together.

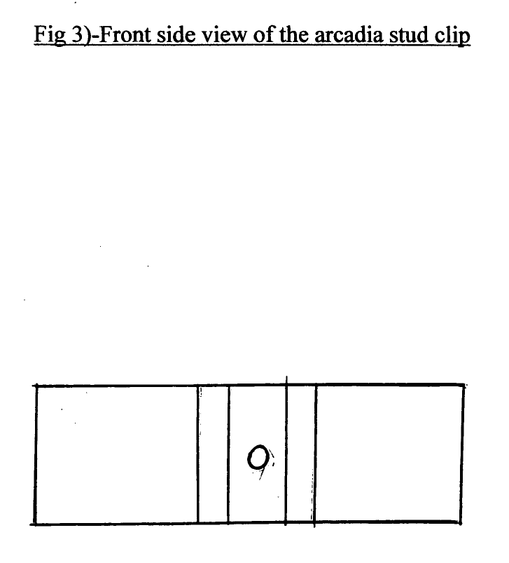

FIG. 4—Front side view 3D of the arcadia stud clip. We can see that the object can clip in both side of the metal stud. This piece will clip the metal stud very tied.

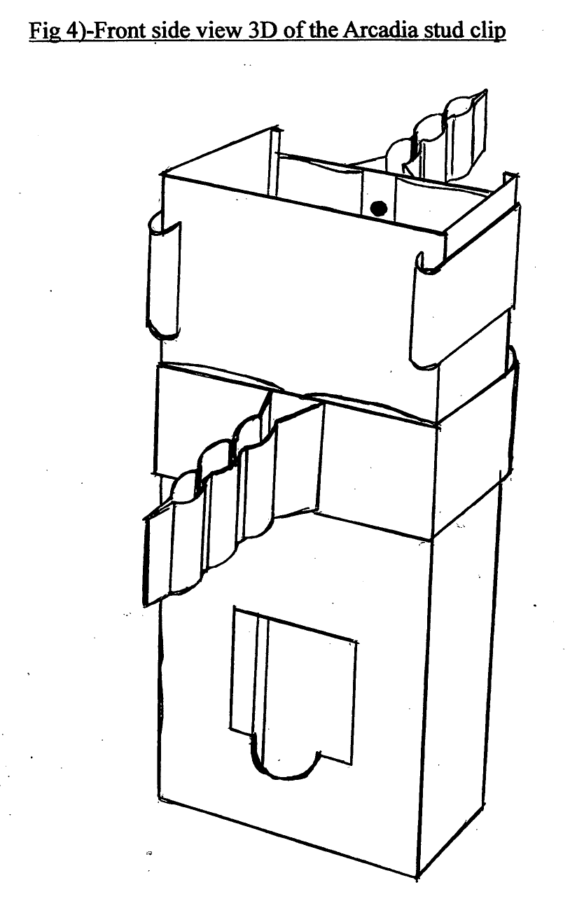

FIG. 5—Front side view 3D of the arcadia stud clip. We can see the piece with the strap for MC cable.

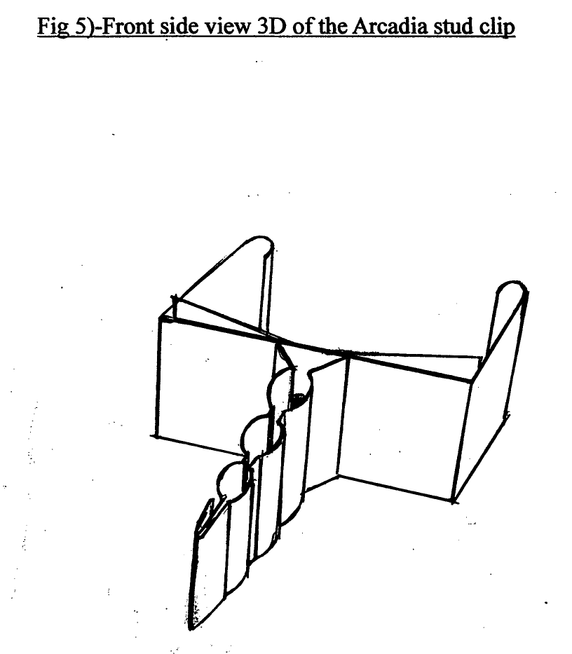

FIG. 6—Back side view of the arcadia stud clip. FIG. A—flex or spring metal that will push the metal stud to the back against to the hooks.

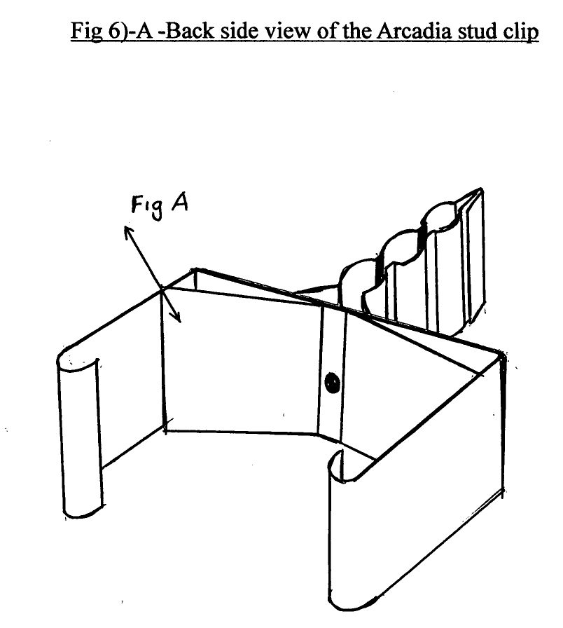

FIG. 7—Right side view of the arcadia stud clip. We can see the two piece separate. FIG. C—the arcadia stud clip and FIG. D—the strap for MC cable. Both piece are attach by a rivet or pop rivet.

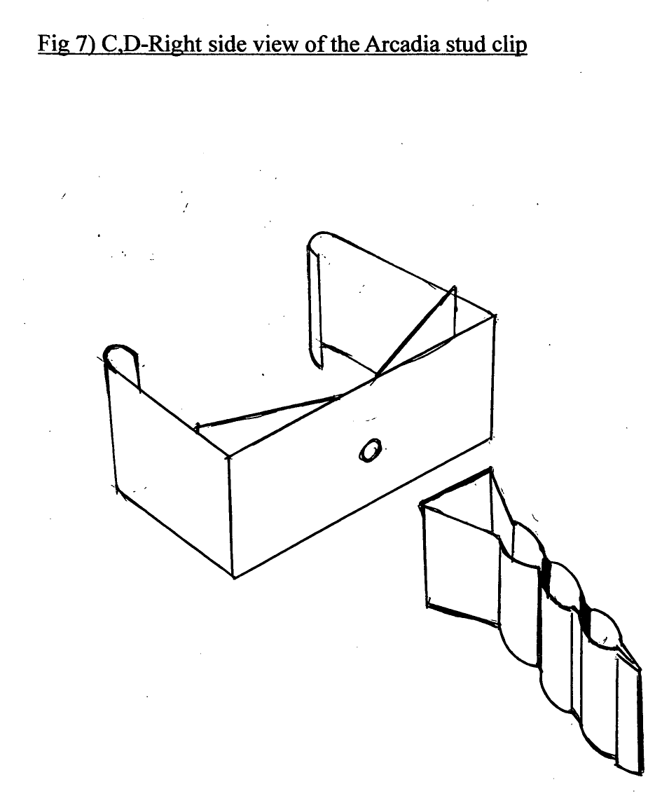

FIG. 8—Front side view of the arcadia stud clip. We can see the object clipped in the metal stud with a strap holding the MC cable.

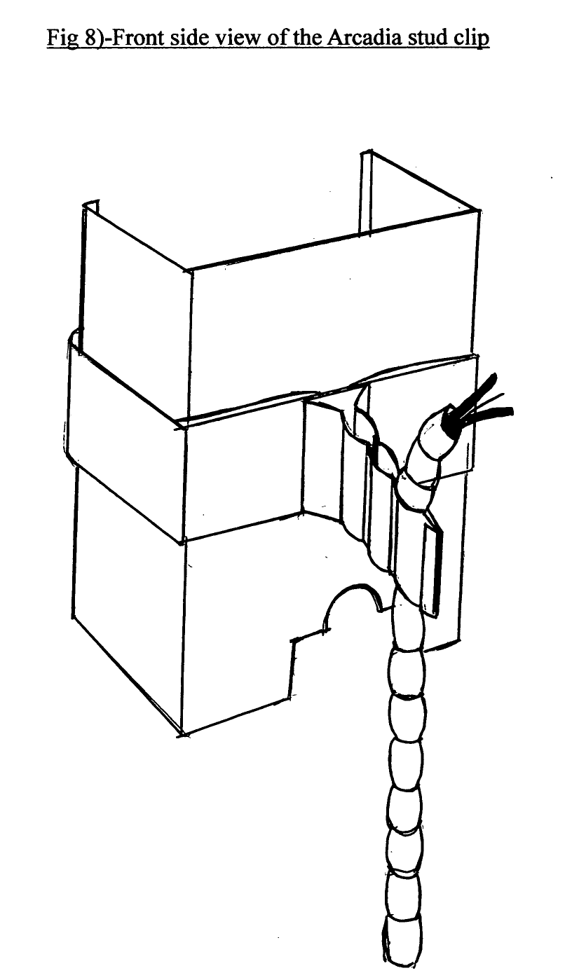

1) I claim that the arcadia stud clip will be use in commercial and residential work, the arcadia stud clip is composed by two piece that are attached by pop rivet or rivet, The first piece is the more important is the press ion clip that will be clipping tied in to the metal stud, and the second piece is the strap that will strapping the MC cable in the center of the metal stud.

2) I claim that the Arcadia stud clip has the design that work with pression, This object work by pushing the arcadia stud clip in to the metal stud all the way in until the two hooks clipping in the back side of the metal stud.

3) I claim that the arcadia stud clip has two different clip 1—is the clip that push with press ion the metal stud to the back and the other clip is the two hook that hold the metal stud. This two clip hold very tied the metal stud, and the arcadia stud clip will clipping in both side of the metal stud.
